(19) United States
(12) Patent Application Publication
(10) Pub. No.: US 2006/0092950 A1
(43) Pub. Date: May 4, 2006

(54) Architecture and method having redundancy in active/active stateful devices based on symmetric global load balancing protocol (sGLBP)

(75) Inventors: Mauricio Arregoces, Rancho Palos Verdes, CA (US); Maurizio Portolani, Milpitas, CA (US); Pere Monclus, San Francisco, CA (US); Ali Golshan, Palo Alto, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/141,808

(22) Filed: May 31, 2005

Related U.S. Application Data
(60) Provisional application No. 60/623,810, filed on Oct. 28, 2004.

(51) Int. Cl. H04L 12/56

(52) U.S. Cl. 370/396

(57) ABSTRACT

An architecture, arrangement, system, and method for or controlling traffic flow into and out of a server farm having active-active stateful devices. A symmetric Gateway Load Balancing Protocol (sGLBP) eliminates asymmetric traffic flow for out-bound traffic. Load distribution for in-bound traffic is balanced between a redundant pair of aggregation switches using either static host routes, Route Health Injection or in a more general manner, with external routes with a mask longer than the connected subnet advertised by the routing protocol. The return traffic is symmetric because it returns through the same aggregation switch that it came from. Similarly, traffic originating from a server farm exits from one of the redundant aggregation switches and returns from the same aggregation switch.

### RELATED APPLICATIONS

This application claims the benefit of U.S. Provisional Application No. 60/623,810, filed Oct. 28, 2004 (Attorney Docket No. 100101-005000), which is incorporated herein by reference in its entirety.

### COPYRIGHT NOTICE

A portion of the disclosure recited in the specification contains material that is subject to copyright protection. Specifically, this application includes source code instructions for a process by which the present invention is practiced in a computer system. The copyright owner has no objection to the facsimile reproduction of the specification as filed in the Patent and Trademark Office. Otherwise, all copyright rights are reserved.

### BACKGROUND OF THE INVENTION

Embodiments of this invention relate in general to data management systems. More specifically, embodiments of this invention relate to architectures, arrangements, systems, and/or operational methods for a server farm.

Server farms house critical computing resources in controlled environments and under centralized management that enable business enterprises to operate around the clock to meet the demands of a global business. Server farm resources include mainframes, web and application servers, file and print servers, messaging servers, application software and operating systems, storage sub-systems and internet protocol (IP) or storage area network (SAN) network infrastructure.

In modern server farms environments, it is typical that two server farms are operated in a manner that provides a level of redundancy. For example, server farms are often configured in pairs, one of which is active and one of which is maintained in a standby mode. In an active-standby topology, only one server farm is active and a client's request is routed to the active site for a specific domain name. The client is only routed to the standby server farm when the active server farm fails or is taken down for maintenance. In another common configuration, both server farms are active in processing traffic with load balancing achieved by making one server farm primary for some traffic to some web sites and the other server farm primary for traffic to other web sites. Regardless of the configuration, there is a need to provide a high level of redundancy, availability and predictability. To achieve these goals, it is common to use Gateway Load Balancing Protocol, also referred to as GLBP, for automatically backing up routers within multiple server farms configured with a single default gateway to a core network. Gateways are a network point where two or more networks connect and are implemented in a device such as a router or a load balancer, operated in a routed mode, and.

In general, GLBP specifies the rules and encoding specifications for sending data to and from the server farm. Members of a GLBP group elect one gateway to be the active virtual gateway (AVG) for that group. Other group members provide backup for the AVG in the event that the AVG becomes unavailable. The AVG assigns a virtual MAC address to each member of the GLBP group. Each gateway assumes responsibility for forwarding packets sent to the virtual MAC address assigned to it by the AVG. These gateways are known as active virtual forwarders (AVFs) for their virtual MAC address.

A GLBP group allows up to four virtual MAC addresses per group. The AVG is responsible for assigning the virtual MAC address to each member of the group in a round robin fashion. Other group members request a virtual MAC address after they discover the AVG through hello messages.

While GLBP is adequate for load balancing between multiple server farms via multiple routers using the round robin routing scheme, there is no provision for maintaining state information for stateful devices such as a load balancer or a firewall. The state maintenance task is complicated because there is no provision in GLBP to ensure that return traffic is directed to the same firewall or load balancer that handled the incoming traffic.

To illustrate an undesirable traffic flow in a server farm, consider the prior art topology of server farm 100 illustrated in FIG. 1. In this topology, two virtualized stateful firewalls 102 and 103 are deployed in a pair of switches 104 and 105. Firewalls 102 and 103 operate in the active-standby context in the transparent mode. GLBP, unlike HSRP and VRRP, makes it possible for the peer routers 106 and 107 to be active concurrently on the VLAN 105 segment, denoted by reference numeral 108. These routers provide greatly needed redundancy for server farm 109. Both routers 106 and 107 advertise the 10.20.51 route, as indicated at 112. In a typical network configuration, peer routers 106 and 107 are cross-coupled by layer three links, indicated 125 and a VLAN 123 handles traffic flow to the standby firewall 103.

With GLBP, client-to-server, or in-bound, traffic, designated by flow arrow 120, is routed along one traffic path through the core router 115 and peer router 106, through one context of the virtual firewall devices 102 to servers in server farm 109 via switch 111. The server-to-client, or out-bound, traffic, as indicated by flow arrow 121, takes a different route through a different contest of virtual firewall 103, peer router 107 and core router 116. Because of the stateful nature of firewalls 102 and 103, they need to see both directions of traffic flows for efficient operation and the non-symmetrical traffic paths prevents stateful device from operating efficiently. To acquire state synchronization in the redundant firewall pair, TCP sequence numbers, a rather complex task, need to be continuously synchronized between the redundant pair of devices. Clearly, such complexity is undesirable. What is needed is a protocol that is robust enough to ensure that stateful service modules, such as load balancers or firewalls, function properly while at the same time ensuring traffic is routed.

### BRIEF DESCRIPTION OF THE DRAWINGS

FIG. 1 illustrates a prior art network topology having asymmetric in-bound and out-bound traffic paths.

FIG. 2 illustrates the network topology of a server farm having symmetrical traffic paths in accordance with an embodiment of the invention.

FIG. 3 is a flow diagram of an exemplary method of controlling traffic flow in a server farm in accordance with an embodiment of the invention.

FIG. 4 is a flow diagram of an exemplary method of controlling in-bound traffic flow in a server farm in accordance with an embodiment of the invention.

FIG. 5 is a flow diagram of an exemplary method of controlling out-bound traffic flow in a server farm in accordance with an embodiment of the invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other electronic device, systems, assemblies, methods, components, parts, and/or the like. In other instances, well-known structures, materials, or operations are not specifically shown or described in detail to avoid obscuring aspects of embodiments of the present invention.

Various embodiments of the invention provide an architecture, arrangement, system, and method for providing a high level of redundancy, availability and predictability in a server farm. The present invention achieves load distribution for incoming traffic to a redundant pair of aggregation switches and the symmetric return of this traffic through the same aggregation switch where it came from. Similarly, traffic originating from the server farm exits from one of the redundant aggregation switches and returns from the aggregation switch from which it exited.

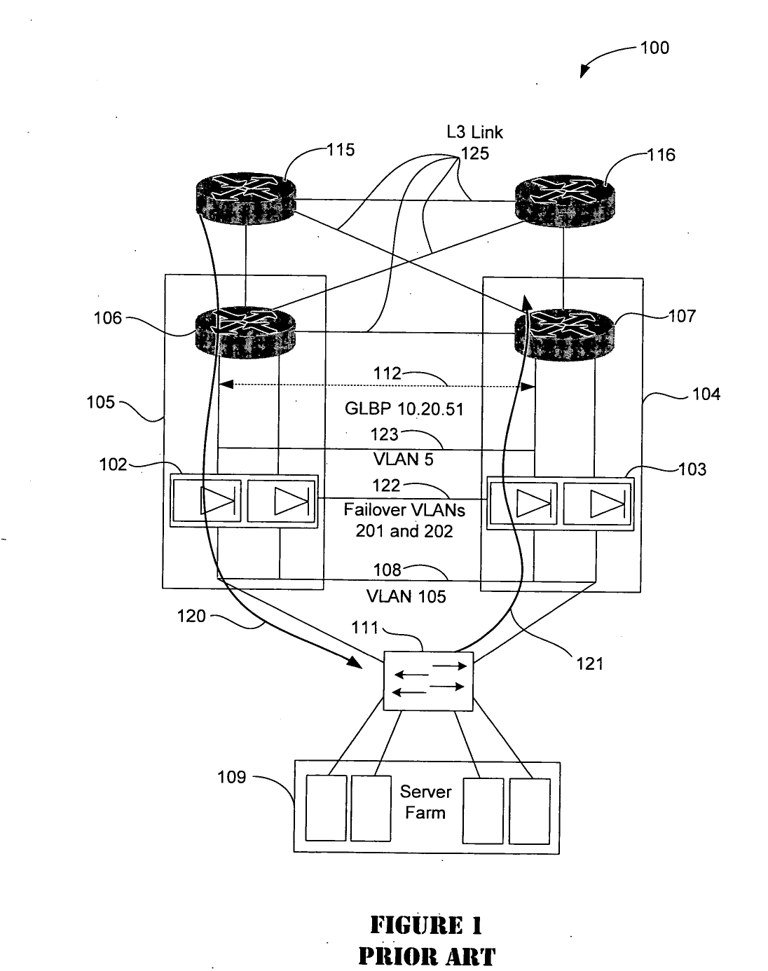

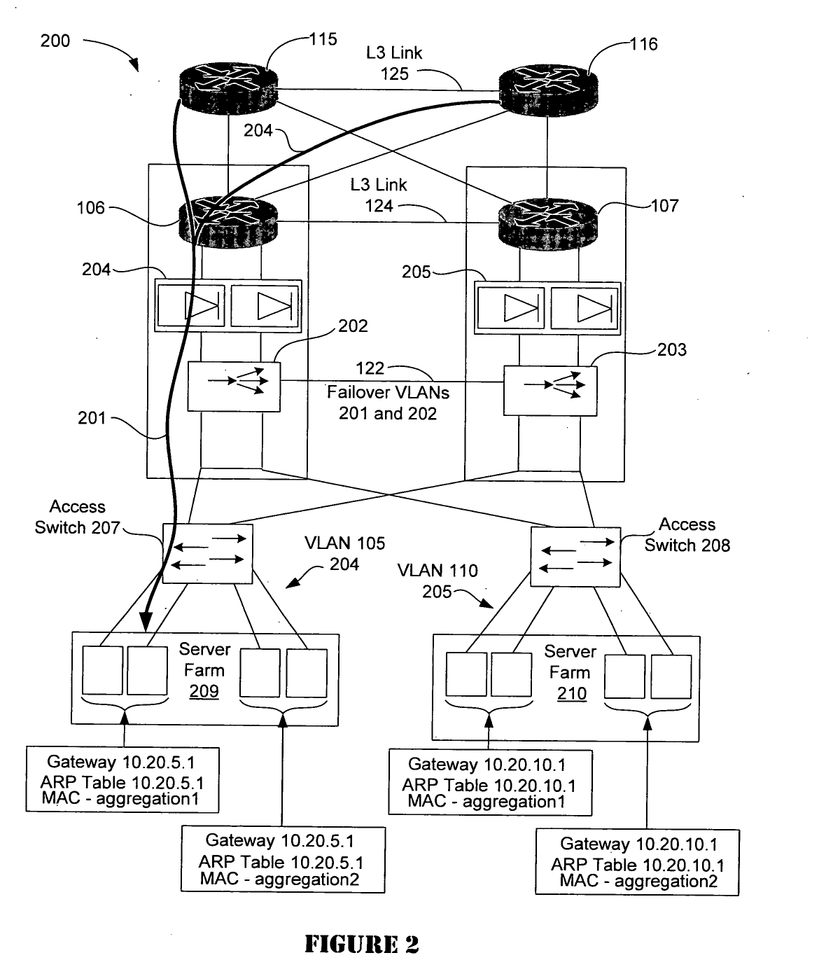

Referring now to the drawings more particularly by reference numbers where like elements have like reference numerals throughout. FIG. 2 illustrates a representative a server farm 200 that has similar topology to that described for FIG. 1 for server farm 100. However, note that VLANs 123 and 108 are no longer required in server farm 200. In this embodiment, server farm 200 includes stateful devices, such as load balancers 202 and 203 and virtual firewalls 204 and 205. Load balancers 202 and 203 together comprise a redundant pair of stateful devices. Similarly, firewalls 204 and 205 together comprise another redundant pair of stateful devices. In this embodiment, the redundant pairs of stateful devices are configured in a chained transparent mode although other configurations are possible. For example, the load balancers could be configured in a one-arm fashion in a routed mode while the firewalls are configured in the transparent mode. In other embodiments, the number of stateful devices could be more or fewer than the number illustrated. In other embodiments, additional stateful devices, such as an intrusion detector system, which although not shown, are well known and could readily be included in the topology of server farm 200.

Rather than deploy redundant pairs of stateful devices with one device active and the other standby, server farm 200 deploys both stateful devices in active mode in accordance with the present invention. This means that both devices are active/active regardless of whether they are deployed in the transparent mode or the routed mode. Since both devices in a redundant pair are active, both devices forward traffic but this means that both devices need to see the incoming (client-to-server) and outgoing (server-to-client) side of their respective traffic flow to perform their intended functions. It will be appreciated that it will be difficult to maintain state synchronization if the incoming traffic were to take one path through one of the pair of redundant devices (for example, load balancer 202) and the outgoing traffic were to take a different path through the other one of the redundant pair (for example, load balancer 203).

Server farm 200 uses symmetric Gateway Load Balancing Protocol (sGLBP) to offer a single virtual IP router while sharing the IP packet forwarding load. Specifically, other routers may act as redundant sGLBP routers that will become active if any of the existing forwarding routers fail. sGLBP provides load balancing over multiple routers (gateways) using a single virtual IP address and multiple virtual MAC addresses. In one embodiment, each server farm is configured with the same virtual IP address, and all routers in the virtual router group participate in forwarding packets.

All Address Resolution Protocol, or ARP, requests for the default gateway from the servers in server farm are directed to the virtual IP address (VIPA). ARP is a network layer protocol that converts an IP address to into a physical address. Only one of the routers is authorized to respond to the ARP request and it is referred to as the Active Virtual Gateway (AVG). This router answers to the ARP requests by performing a round robin among a number of virtual MAC addresses (two MACs in this example). Each virtual MAC address identifies a router in the sGLBP group.

The AVG, by answering with different virtual MACs to different servers in server farms 209 and 210, distributes traffic load to and from the server farm. In this manner, half of the servers use Aggregation1 (router 106) as their default gateway and the other half uses Aggregation2 (router 107). Each router 106 and 107 is an Active Virtual Forwarder (AVF) for a given virtual MAC. Should Aggregation1 fail, Aggregation2 becomes the AVF for both virtual MACs.

The additional configuration efforts and added complexity to support the active-active environment are significant. The main challenge with an active-active configuration for the same VIPA is the result of having the same MAC and IP addresses active in two different places concurrently. The problem arises from the requirement that the active load balancer must receive all packets for the same connection, and all connections from the same session. The devices that are upstream from the load balancers, which are routers 106 and 107 or the Layer 3 switches, are typically not aware of connections or sessions as these devices merely select the best path for sending the traffic. Depending on the cost of each of the paths and the internal switching mechanisms of the Layer 3 devices, the traffic might be switched on a per-packet basis, on source/destination IP addresses, and so on.

Accordingly, in one embodiment of the present invention, inbound traffic is artificially forced to follow a selected path through only one of the load balancers. To ensure state information is maintained, the present invention uses sGLBP to force return and outbound traffic paths to selected stateful devices. FIG. 3 illustrates one method maintaining state information. Essentially, as indicated at step 302 in-bound or client-to-server traffic is controlled so that is directed to specific servers in the server farm. As indicated at step 304, out-bound or server-to-client traffic from the server farm is directed back along a symmetric path with sGLBP. Because of the stateful nature of the load balancer, it is necessary to control both the incoming and the outgoing traffic flows to achieve symmetric flows. It is only with symmetric flow that the stateful devices will see both directions of traffic flows. Thus, controlling both in-bound and out-bound traffic flow is necessary.

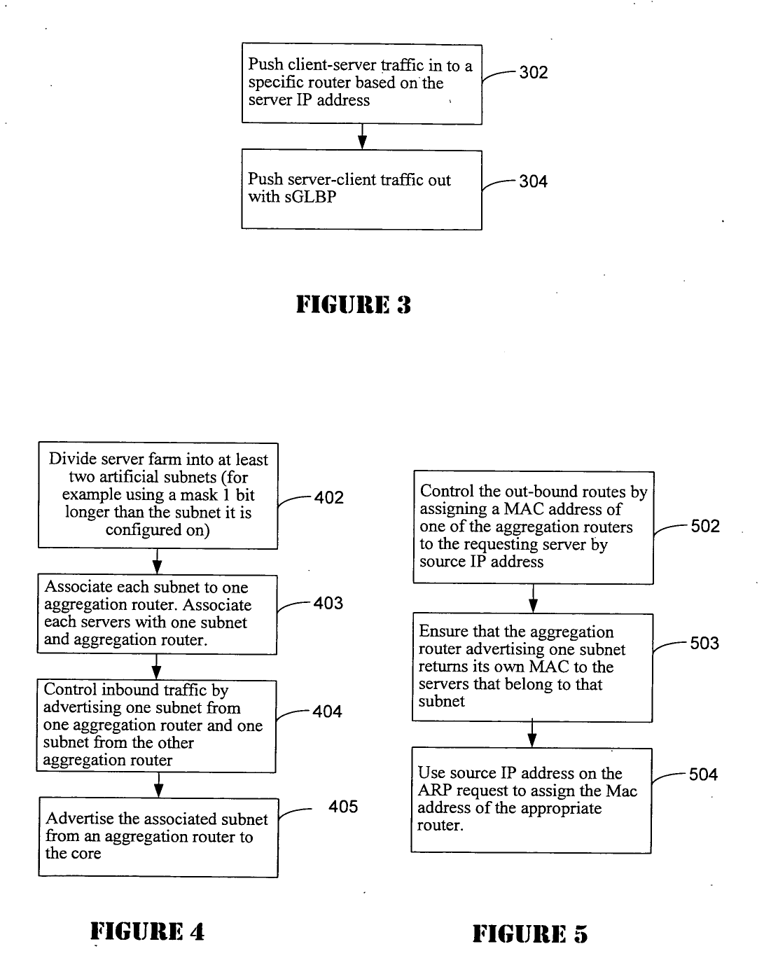

FIG. 4 illustrates one embodiment for control of in-bound traffic flow in accordance with embodiments of the present invention. Initially, the server farm must be artificially divided into at least two subnets at indicated at step 402. Then servers in each subnet are associated with one of the at least two aggregation routers, as indicated at step 403. Once associated, in-bound traffic must be controlled so that it passes through a known stateful device as indicated at step 404. Finally, in step 404, each router 106 and 107 advertises its associated subnets to the core routers 115 and 116.

Referring again to step 404, traffic may be controlled in several different methodologies. For example, inbound traffic can be controlled by injecting host routes in the routing table of routers 105 and 106 or by configuring external routes with a mask that is longer than the connected subnet advertised by the routing protocol. Note that RHI is commercially available on either an IOS-SLB (server load balancer) or a Content Switching Module (a load balancer) both available from Cisco Systems, the parent corporation of the assignee of the present application. RHI monitors the availability of servers in each subnet and if the server is available it installs a static host route into routing tables based on the availability. A host route is a route that has a mask of length equal to that of the IP address, or 32 bits and specifies a single host. Since many routers implement an optimized longest prefix match route lookup, routes of a finer granularity than that of subnet ranges can be used to make forwarding decisions. The use of longest prefix matching enables the use of host routes to forward traffic in a direction different from that of the rest of the subnet range because the most specific route is always preferred. Thus, RHI allows in-bound client to server traffic to be directed into the server farm from the core routers 115 and 116.

Alternatively, external routes with a mask longer than the connected subnet advertised by the routing protocol are specified to direct the in-bound traffic to the desired subnet. Once the routes are installed, the respective subnets are advertised to the core from the aggregation routers as indicated at step 405.

To illustrate the method illustrated in FIG. 4, assume that the routing table at peer routers show the following entries as illustrated in Table 1:

TABLE 1

| | |
|---|---|
| • | 10.20.5.0/24 [110/20] via 10.21.0.5, 00:00:09, GigabitEthernet4/8 |
| C | 10.21.0.4/30 is directly connected, GigabitEthernet4/7 |
| • | 10.20.3.0/24 [110/20] via 10.21.0.5, 00:00:09, GigabitEthernet4/7 |
| • | 10.21.0.0/30 [110/20] via 10.21.0.5, 00:00:09, GigabitEthernet4/7 |
| • | 10.20.44.0/24 [110/20] via 10.21.0.5, 00:00:09, GigabitEthernet4/7 |
| • N1 10.20.5.80/32 [110/22] via 10.21.0.5, 00:00:09, GigabitEthernet4/7 | |

Thus, traffic directed to 10.20.5.80 takes the static route, GigabitEthernet4/7.

In one embodiment, the Enhanced Interior Gateway Routing Protocol (EIGRP) protocol is combined with RHI to configure in-bound routers for controlling traffic flow. The advantages of Enhanced IGRP range from the overall simplicity of configuration and the flexibility of summarization to the localization of routing table changes and fast convergence, which result from the operation of a Diffusing Update Algorithm (DUAL) mechanism. The DUAL mechanism enables EIGRP routers to determine whether a path advertised by a neighbor is looped or loop-free, and allows a router running EIGRP to find alternate paths without waiting on updates from other routers. Further, EIGRP supports for variable-length subnet mask that permits routes to be automatically summarized on a network number boundary. However, from the perspective of EIGRP, any routes not originated within the protocol are external routes, as, for example, the RHI derived routes. Thus, the summarization that occurs by default at major network boundaries in EIGRP does not include summarization of RHI routes. However, a mechanism within EIGRP allows for the configuration of summarization ranges, which can include RHI routes.

Referring again to FIG. 2, if load balancer 202 is active on the aggregation1 side (that is traffic flow is through router 106), the RHI host route is installed by the load balancer on router 106 and the redistributed route is originating only from router 106. The routing tables on core routers 115 and 116 are such that the traffic from either router 115 or 116 goes directly to router 106, where load balancer 202 is active. Configuration code for one embodiment of the present invention is shown in Table 2.

TABLE 2
mp_core2#show ip eigrp topology 10.20.5.80 255.255.255.255
IP-EIGRP topology entry for 10.20.5.80/32

State is Passive, Query origin flag is 1, 1 Successor(s), FD is 5376
Routing Descriptor Blocks:
10.21.0.5 (GigabitEthernet4/7), from 10.21.0.5, Send flag is 0x0

Composite metric is (5376/5120), Route is External
Vector metric:

Minimum bandwidth is 1000000 Kbit.
Total delay is 110 microseconds
Reliability is 255/255
Load is 1/255
Minimum MTU is 1500
Hop count is 1

External data:

Originating router is 10.10.10.3
AS number of route is 0
External protocol is Static, external metric is 0
Administrator tag is 0 (0x00000000)

10.21.0.13 (GigabitEthernet4/8), from 10.21.0.13, Send flag is 0x0

Composite metric is (5632/5376), Route is External
Vector metric:

Minimum bandwidth is 1000000 Kbit
Total delay is 120 microseconds
Reliability is 255/255
Load is 1/255
Minimum MTU is 1500
Hop count is 2 <<<<<<<<<<<<<<<<<<<<<<<

External data:

Originating router is 10.10.10.3
AS number of route is 0
External protocol is Static, external metric is 0
Administrator tag is 0 (0x00000000)

10.0.0.1 (GigabitEthernet1/1), from 10.0.0.1, Send flag is 0x0

Composite metric is (5632/5376), Route is External
Vector metric:

Minimum bandwidth is 1000000 Kbit
Total delay is 120 microseconds
Reliability is 255/255
Load is 1/255
Minimum MTU is 1500
Hop count is 2 <<<<<<<<<<<<<<<<<<<<<

External data:

Originating router is 10.10.10.3
AS number of route is 0
External protocol is Static, external metric is 0
Administrator tag is 0 (0x00000000)

Since load balancer 202 is active in aggregation1 (router 106), the client traffic from the core takes either highlighted path 201 or path 204 to server farm 206.

To ensure a symmetric return traffic path, sGLBP controls the out-bound routes as indicated in step 304 in FIG. 3. FIG. 5 illustrates one embodiment for control of out-bound traffic flow in accordance with embodiments of the present invention. Specifically, out-bound traffic is preferably controlled by assigning a MAC address of one of the aggregation routers to a requesting server based on the source IP address of the server as indicated at step 502. With sGLBP it is possible to associate the out-bound traffic with the MAC address of the aggregations routers that handled the in-bound traffic. Then, sGLBP inserts two static routes with a mask 1 bit longer than the subnet it is configured on as indicated at step 503. sGLBP uses the source IP address on the ARP request to assign the MAC address of the appropriate gateway router as indicated at step 504. In this manner the combination of RHI to assign static host routes and sGLBP to control outbound routes it is possible to achieve symmetric paths for traffic incoming and outgoing in a server farm.

Symmetric GLBP performs two functions. First, two static routes are inserted into the routing table. These routes have a mask one bit longer than the subnet on which it is configured. Then, the source IP address is used on the ARP request to assign the MAC address of the appropriate router.

To illustrate, aggregation1 (router 106) may be configured as follows:
router(config)#interface Vlan5
router(config-if)#ip address 10.20.5.252 255.255.255.0
router(config-if)#glbp 1 ip 10.20.5.1
router(config-if)#glbp 1 load-balancing symmetric 1
router(config-if)#glbp 1 priority 110
and 0007.B400.0101 is the virtual MAC for Aggregation1.

Further, aggregation2 (router 107) may be configured as follows:
router(config)#interface Vlan5
router(config-if)#ip address 10.20.5.253 255.255.255.0
router(config-if)#glbp 1 ip 10.20.5.1
router(config-if)#glbp 1 load-balancing symmetric 1
router(config-if)#glbp 1 priority 105
and 0007.B400.0102 is the virtual MAC for Aggregation2.

Symmetric GLBP automatically performs three tasks on aggregation1. First, it inserts a static route such as, by way of example:
ip route 10.20.5.0 255.255.255.128 vlan 5.

Second, it resolves the ARP for 10.20.5.1 from hosts in the range 10.20.5.2-10.20.5.126 to be 0007.B400.0101. Finally, it resolves the ARP for 10.20.5.1 from hosts in the range 10.20.5.128-10.20.5.254 to be 0007.B400.0102.

Symmetric GLBP then automatically performs the three tasks on aggregation2. First, it inserts a static route such as by way of example:
ip route 10.20.5.128 255.255.255.128 vlan 5.

Then it resolves the ARP for 10.20.5.1 from hosts in the range 10.20.5.2-10.20.5.126 to be 0007.B400.0101. Then it resolves the ARP for 10.20.5.1 from hosts in the range 10.20.5.128-10.20.5.254 to be 0007.B400.0102.

Load distribution for in-bound traffic while preserving symmetric paths for traffic incoming and outgoing in a server farm is achieved by sending half of the incoming traffic for subnet 10.20.5.x to aggregation1 and the remaining traffic to aggregation2. In order achieve the load distribution, the subnet is artificially divided into two subnets. Specifically, subnet 10.20.5.x is divided into subnets 10.20.5.0/25 and 10.20.5.128/25. Each aggregation router 106 and 107 advertises one of the subnets. For example, aggregation1 advertises 10.20.5.0/25 as an external route and aggregation2 advertises 10.20.5.128/25 as an external route. The servers in the 10.20.5.x subnet belong to either one of these two subnets. Servers 10.20.5.1 through 10.20.5.126 receive traffic from aggregation1. Servers 10.20.5.129 through 10.20.5.154 consistently receive traffic from aggregation2.

Load distribution for the outgoing traffic means that servers 10.20.5.1-10.20.5.126 take aggregation1 on the way out to the core, and that the servers 10.20.5.129-10.20.5.254 take aggregation2. In order to do this traffic distribution, sGLBP returns the MAC address of aggregation1 when the source IP address of the host ARPing for 10.20.5.1 belongs to the 10.20.5.0/25 subnet. Alternatively, sGLBP returns the MAC of aggregation2 when the source IP address of the host ARPing for 10.20.5.1 belongs to the 10.20.5.128/25 subnet. Thus, when a VLAN interface is configured for /24 subnets, sGLBP must hash on the 25^{th} bit of the host IP address that is ARPing for the default gateway.

Referring again to FIG. 2, the operation of sGLBP with transparent firewalls and load balancers is shown. By adding a transparent stateful device to a loop free topology that uses sGLBP, the default gateway for the servers is the upstream router 106 where sGLBP is configured. Symmetric GLBP ensures symmetric paths in and out of the serverfarm, so when a firewall or other stateful device in aggregation1 sees an incoming flow, it also sees the associated outgoing flow. Similarly, when its redundant peer in aggregation2 sees an incoming flow, it too will also see the associated outgoing flow.

Note, there should b no blocking link. This is the case for GLBP in general because GLBP does not function with blocking links. For this reason, there are no trunk VLANs between the aggregation switches 106 and 107. There is no reason (besides the current implementation of redundancy on service modules) to trunk the outside and inside VLANs between the aggregation switches. Only the failover VLAN 122 connects the service modules for state synchronization. Both contexts are active concurrently on both devices and no loop is intrinsically present in the topology.

Stateful devices can operate in either a Layer 3 or a Layer 2 mode. In Layer 3 mode, the load balancers and firewalls provide the default gateway function. In Layer 2 mode load balancers and firewalls just bridge traffic between a client side and a server side VLAN. If stateful devices are deployed in Routed Mode, the same mechanism can be applied. The gateway protocol that the stateful device should implement is GLBP and RHI is used to inject the static routes into routers 106 and 107 with a next hop address that equals the IP address of the stateful device.

Load distribution of traffic from the core to the aggregation switches is very effective if addresses in the /24 subnet are allocated in the full range 10.20.5.2-10.20.5.250. However, if the servers in a server farm are addressed from 10.20.5.2-10.20.5.70 for example, there is no load distribution at all. Clearly, the addressing scheme in the server farm should be changed to start addressing some servers ascending and other servers descending, but this is an administration action and out of the control of GLBP. Thus, in accordance with the present invention, a solution consists in hashing not on the 1^{st} bit in the subnet, but rather on the 1^{st} and 2^{nd} bit. For example, instead of dividing the network into 10.20.5.0/25 and 10.20.5.128/25, symmetric GLBP could artificially divide the network in four subnets: 10.20.5.0/26, 10.20.5.64/26, 10.20.5.128/26 and 10.20.5.192/26. The configuration of sGLBP enables the system administrator to indicate how many bits to use for the hash or artificial subnetting.

To illustrate the configuration for a single bit of hashing consider the following:
router(config)#interface Vlan5
router(config-if)#ip address 10.20.5.252 255.255.255.0
router(config-if)#glbp 1 ip 10.20.5.1
router(config-if)#glbp 1 load-balancing symmetric 1
router(config-if)#glbp 1 priority 110.

To illustrate the configuration for two bit of hashing consider the following:
router(config)#interface Vlan5
router(config-if)#ip address 10.20.5.252 255.255.255.0
router(config-if)#glbp 1 ip 10.20.5.1
router(config-if)#glbp 1 load-balancing symmetric 2
router(config-if)#glbp 1 priority 110.

Accordingly, the present invention provides an architecture and method that allows traffic to be symmetrically pushed back to the same server load balancer from which it came. A modified GLBP algorithm means that when the server asks for the gateway address, it is given a MAC address that defines which stateful device gets the traffic. Load balancing is achieved by dividing the server farm subnet into smaller ranges of IP addresses. From the outside core, two different subnets are advertised. From server side, the server sees the gateway but two MAC addresses are used to forward the traffic.

Various embodiments of the present invention include architectures, arrangements, systems, and/or methods for controlling traffic in a server farm. Any traffic that comes in on one path will go out along the same path. In one embodiment, RHI controls in-bound traffic and sGLBP controls out-bound traffic. The control scheme eliminates loops that would compromise the integrity of a stateful device, such as a firewall or load balancer.

Although the invention has been discussed with respect to specific embodiments thereof, these embodiments are merely illustrative, and not restrictive, of the invention. The invention can operate in a variety of systems and server and/or processing arrangements. Any suitable programming language can be used to implement the routines of the invention, including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Further, various architectures and types of circuits, such as switch implementations, can be used in accordance with embodiments.

In the description herein for embodiments of the invention, numerous specific details are provided, such as examples of components and/or methods, to provide a thorough understanding of embodiments of the invention. One skilled in the relevant art will recognize, however, that an embodiment of the invention can be practiced without one or more of the specific details, or with other electronic device, systems, assemblies, methods, components, materials, parts, and/or the like. In other instances, well-known structures, materials, or operations are not specifically shown or described in detail to avoid obscuring aspects of embodiments of the invention.

Reference throughout this specification to “one embodiment”, “an embodiment”, or “a specific embodiment” means that a particular feature, structure, or characteristic described in connection with the embodiment is included in at least one embodiment of the invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the invention may be combined in any suitable manner with one or more other embodiments. It is to be understood that other variations and modifications of the embodiments of the invention described and illustrated herein are possible in light of the teachings herein and are to be considered as part of the spirit and scope of the invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. In a server farm, method for directing traffic to achieve a symmetrical traffic flow, said method comprising:
Controlling in-bound traffic from a client to a server along a selected traffic path; and
Controlling out-bound traffic from said server to said client by supplying a gateway MAC address that corresponds to said selected traffic path.

2. The method of claim 1, wherein said server farm is divided into at least two artificial subnets to partition traffic.

3. The method of claim 2 wherein said in-bound traffic is controlled by injecting a route into a gateway for partitioning traffic to a subnet of said server farm.

4. The method of claim 3 wherein said outbound traffic is controlled with symmetrical Global Load Balancing Protocol (sGLBP).

5. The method of claim 4 wherein said sGLBP advertises said least two artificial subnets and resolves MAC requests based on the source IP address of said requestor.

6. The method of claim 5, wherein at least one stateful device is in the path for both said controlled inbound traffic and said outbound traffic.

7. The method of claim 6 wherein said stateful devices comprise a redundant pair each of which operates in an active mode.

8. The method of claim 7 wherein said active/active redundant pair comprises a load balancer configured in a transparent mode.

9. The method of claim 7 wherein said active/active redundant pair comprises firewall contexts configured in a transparent mode.

10. The method of claim 9 wherein said active/active redundant pair comprises firewall contexts and load balancers configured in a chained transparent mode.

11. A method for symmetrically directing traffic to a server farm comprising:
Dividing said server farm into at least two artificial subnets;
Associating servers in each of said artificial subnets with an aggregation router;
Installing a route on said aggregation router for inbound client to server traffic; and
Advertising the associated subnet from an aggregation router to at least one core router.

12. The method of claim 11 wherein said controlling step further comprises the step of selecting at least one of the following for controlling in-bound client to server traffic:
a. Configuring a host route for each subnet on an aggregation router;
b. Selecting external routes with a mask longer than the connected subnet advertised by the routing protocol at said aggregation router.

13. The method of claim 11 further comprising controlling out-bound routes from said server farm by assigning a MAC address corresponding to the aggregation routers associated with said requesting server.

14. The method of claim 12 wherein said assigning step further comprises the step of associating a source IP address on the ARP request from the requesting server to the Mac address of the gateway such that both inbound and outbound routes are symmetric.

15. The method of claim 14, wherein said server farm is divided into at least two artificial subnets to partition traffic.

16. The method of claim 14 wherein said out-bound traffic is controlled with symmetrical Global Load Balancing Protocol (sGLBP).

17. The method of claim 14, wherein at least one stateful device is in the path for both said controlled inbound traffic and said outbound traffic.

18. The method of claim 17 wherein said stateful devices comprise a redundant pair each of which operates in an active mode.

19. A server farm comprising:
means for artificially partitioning said server farm into a plurality of subnets;
a plurality of peer aggregation routers adapted to advertise one of a plurality of virtual IP addresses for each subnet of said server farm, said addresses installed by injecting an inbound route; each of said peer aggregation routers having a protocol for responding to a gateway request from a server in one of said subnets with a MAC address of one of said peer aggregation routers corresponding to the advertised address; and
at least one stateful device coupled between said aggregation routers and said server farm in transparent mode such that both the inbound traffic path and the outbound traffic path pass through said at least one stateful device.

20. The server farm of claim 19 wherein said stateful device comprises a redundant pair each of which operates in an active mode.
